(19) United States
(12) Patent Application Publication
(10) Pub. No.: US 2004/0015817 A1
(43) Pub. Date: Jan. 22, 2004

(54) Object processing system having an object model

(76) Inventors: Toni Kress, Lauf (DE); Dieter Walter, Hessdorf (DE)

Correspondence Address: HARNESS, DICKEY & PIERCE, P.L.C., P.O.BOX 8910, RESTON, VA, 20195, US

(21) Appl. No.: 10/120,513

(22) Filed: Apr. 12, 2002

(30) Foreign Application Priority Data
Apr. 12, 2001 (DE) 10118470.0

(51) Int. Cl. G06F 9/44

(52) U.S. Cl. 717/101

(57) ABSTRACT

A data structure includes global objects that can be used by a plurality of project planning tools, via which partial plans of a technical installation can be prepared using their correspondingly tool-specific design criteria. The data structure can be accessed from the project planning tools only via a management program assigned to the data structure which generates, deletes and modifies the global objects as a function of use by the project planning tools. Further, if appropriate, it generates warning messages for the project planning tools.

The present application hereby claims priority under 35 U.S.C. Section 119 on German patent application number DE 10118470.0 filed Apr. 12, 2001, the entire contents of which are hereby incorporated herein by reference.

### FIELD OF THE INVENTION

The present invention generally relates to an object processing system having an object model. Preferably, the object model includes a data structure with global objects that can be used by a plurality of project planning tools. Preferably, it is possible to prepare partial plans of a technical installation using the project planning tools in accordance with tool-specific design criteria.

### BACKGROUND OF THE INVENTION

Project planning of technical, in particular electrotechnical, installations is subject to a high level of pressure in terms of time and costs. As a rule, during the project planning of such installations, many persons participate to use the various project planning tools that are respectively tailored to the special features of the corresponding projection planning task. Examples of such projection planning tools are those used to prepare circuit diagrams, cable lists, parts lists, net lists and terminal diagrams.

Known in the prior art are project planning tools that operate internally with an object-oriented data management, and thus ensure a continuity of project planning inside the project planning tool. However, data assigned in proprietary fashion to the respective tools are accessed by the individual tools independently of one another. This holds likewise for instances of reading access and writing access.

The information items assigned to the project planning tools and corresponding to one another can be or become inconsistent relative to one another because of mutually independent instances of access. In order nevertheless to achieve consistency of information, checking runs and mapping mechanisms are carried out expensively in the prior art. Nevertheless, consistency of the data is not always ensured, or data get lost. The latter holds in particular when the same object is manipulated by a plurality of tools. Again, data may have to be input repeatedly when the corresponding mapping mechanisms are not available. Furthermore, the mapping mechanisms have to be programmed.

### SUMMARY OF THE INVENTION

An object of an embodiment of the present invention includes creating an object processing system. Preferably, consistent data management is ensured in a simple way.

An object can be achieved by virtue of at least one of

the object model also has a management program for the data structure,

the data structure can be accessed from the project planning tools only via the management program,

the global objects can be generated, deleted and modified by the management program as a function of use by the project planning tools, and

in the case of the modification of a global object using one of the project planning tools, the management program generates modification messages for the other project planning tools using this global object.

Access to global objects by the respective project planning tool can be particularly simple when the project planning tools internally generate a reference to the global object for each use of a global object via the respective project planning tool.

The prescription of a use of a global object by one of the project planning tools can be particularly convenient when a use of a global object in one of the project planning tools can be prescribed by selecting an existing reference in another one of the project planning tools, determining the assigned global object and internally generating a reference to the global object in the one project planning tool.

The prescription of a use can be particularly simple when a use of a global object in one of the project planning tools can be prescribed alternatively or in addition by selection from a list of the global objects.

A hidden generation of global objects can be performed for the user of one of the project planning tools when a preparation of an object using one of the project planning tools that is intended to be capable of use by at least one further project planning tool can be interpreted by the management program as a request for generating a corresponding global object and for one project planning tool to use the global object.

It is always known by how many tools a global object is being used when the management program runs a reference counter for each global object, the reference counter is set to the value one upon first-time use of the assigned global object, the value of the reference counter is incremented with each use of the global object in another of the project planning tools, and the value of the reference counter is decremented with each termination of the use of the global object in one of the project planning tools.

When a deletion of the global object is undertaken only when the reference counter is already assigned the value one and the last use of the global object in one of the project planning tools is deleted, it can be ensured in a simple way that the partial plans of the other project planning tools remain as per design.

Alternatively, it is possible also to undertake deletion of the global object when the reference counter is assigned a value differing from one, and in that the management program generates a warning message on the basis of the deletion. In this case, the warning message ensures that appropriate modifications can be carried out in the project planning tools concerned.

When upon generation of a global object, via the requesting project planning tool, access authorizations for the other project planning tools can be prescribed, the possible uses for this global object can be adapted by the other project planning tools. In particular, it is possible, for example, to permit deletion and modification of the global object only by the generating project planning tool.

The generation of global objects can be particularly simple when predefined object types are used for the generation of global objects.

Access to global objects can be particularly error-tolerant when the global objects are defined in a mark up language.

The object model can alternatively be a unit separated from the project planning tools or integrated in one of the project planning tools.

A typical application of the present invention can be an object model for project planning tools for the project planning of a low-voltage power distribution system. In this case, in particular, the project planning tools can include at least two of the following project planning tools:

a project planning tool for preparing a circuit diagram,

a project planning tool for preparing a cable list,

a project planning tool for preparing a net list,

a project planning tool for preparing a parts list,

a project planning tool for preparing a terminal diagram,

a project planning tool for preparing an element specification,

a project planning tool for preparing a communication plan,

a project planning tool for testing and/or dimensioning a circuit diagram.

### BRIEF DESCRIPTION OF THE DRAWINGS

Further advantages and details emerge from the following description of an exemplary embodiment. In this case, in the drawings illustrating the principle

FIG. 1 shows an object processing system,

FIG. 2 shows a global object, and

FIGS. 3-9 show flowcharts.

### DETAILED DESCRIPTION OF THE PREFERRED EMBODIMENTS

In accordance with FIG. 1, a technical installation is to be project planned using a plurality of project planning tools 1 to 3. The technical installation can be a low-voltage power distribution system, for example. The project planning tools 1 to 3 therefore include at least two of the following project planning tools:

a project planning tool for preparing a circuit diagram,

a project planning tool for preparing a cable list,

a project planning tool for preparing a net list,

a project planning tool for preparing a parts list,

a project planning tool for preparing a terminal diagram,

a project planning tool for preparing an element specification,

a project planning tool for preparing a communication plan,

a project planning tool for testing and/or dimensioning a circuit diagram.

Partial plans of the technical installation can thus be prepared using the project planning tools 1 to 3, in accordance with tool-specific design criteria.

In order to prepare the respective partial plan, each of the project planning tools 1 to 3 accesses data 4 to 6 assigned to it in a proprietary fashion. The projection planning tools 1 to 3 also access global objects 7 that are combined to form a data structure 8. The global objects 7 are used by at least two of the project planning tools 1 to 3. Access to the global objects 7 is performed in this case without exception via a management program 9 for the data structure 8. The data structure 8 and the management program 9 together form an object model 10.

In accordance with FIG. 1, the object model 10 is a unit separated from the project planning tools 1 to 3. The object model 10 could, however, also be integrated in one of the project planning tools 1 to 3, for example the project planning tool 2. This is indicated in FIG. 1 by a dashed and dotted frame.

In accordance with FIG. 1, the global objects 7 include various data. Firstly, they include their address 11, the type 12 of the element being described, as well as a specification 13 of the respective element. They also include a counter 14, the significance of which will be addressed later.

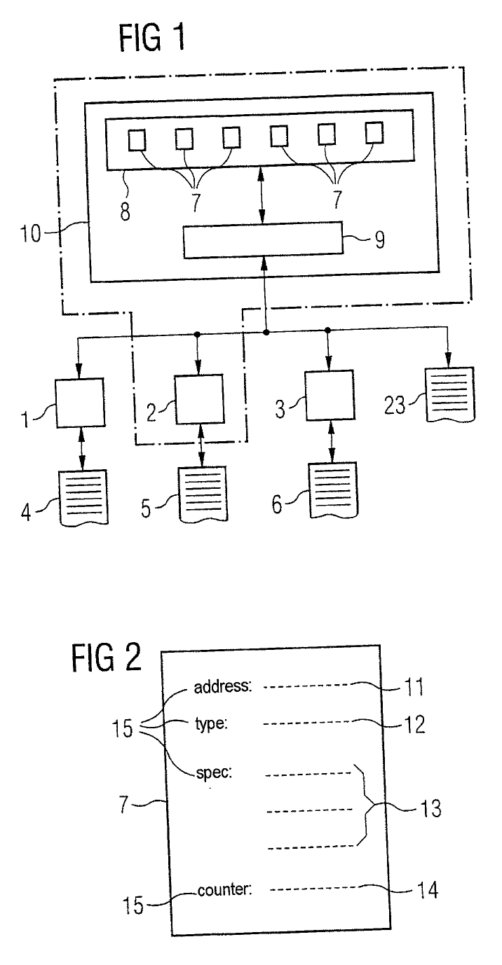

In accordance with FIG. 2, the data 11 to 14 of the object 7 are respectively preceded by an information item 15 which explains the significance to be attached to the respective item of data 11 to 14. The global objects 7 are therefore defined in a markup language. For example, they can be defined in what is termed XML (=extended markup language).

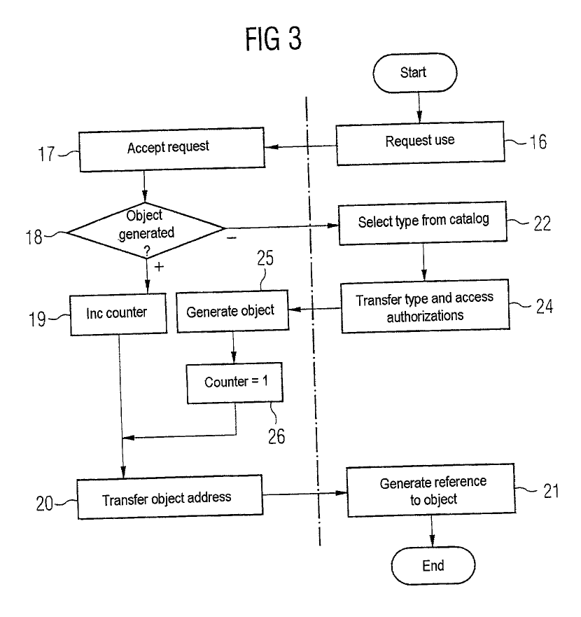

In accordance with FIG. 3, in the case of appropriate project planning in one of the project planning tools 1 to 3 the respective project planning tool 1 to 3 requests a global object 7 in a step 16 of the management program 9. The request is accepted by the management program 9 in a step 17, and then checked in a step 18 as to whether the respective object 7 has already been generated. If yes, the counter 14 of this object 7 is incremented in a step 19, and the address 11 is transferred in a step 20 to the requesting project planning tool 1 to 3. The latter then generates a reference to the global object 7 internally in a step 21.

If the object 7 has not yet been generated, this is reported back in the course of step 18 to the requesting project planning tool 1 to 3. The latter then fetches predefined object types from a catalog 23 in a step 22. An object—still not a global one—is then prepared by selection of one of the predefined object types.

Since the selected object type is to be capable of being used by at least one further one of the project planning tools 1 to 3, the selected type is transferred in a step 24 to the management program 9. In a step 25, the latter then generates the global object 7 and sets the counter 14 thereof to the value 1 in a step 26. The preparation of the (still local) object by the respective project planning tool 1 to 3 is therefore interpreted by the management program 9 on the basis of the transfer of the type as a request for generating a corresponding global object 7 and use of the global object 7 by this project planning tool 1 to 3.

In the course of the transfer of the object 7 in step 24, the management program 9 is simultaneously prescribed access authorizations for the other project planning tools 1 to 3 by the transferring project management tool 1 to 3. For example, instances of writing access to this global object 7 can be completely blocked by the other project planning tools 1 to 3. The global object 7 can then be deleted and modified only by the generating project planning tool 1 to 3.

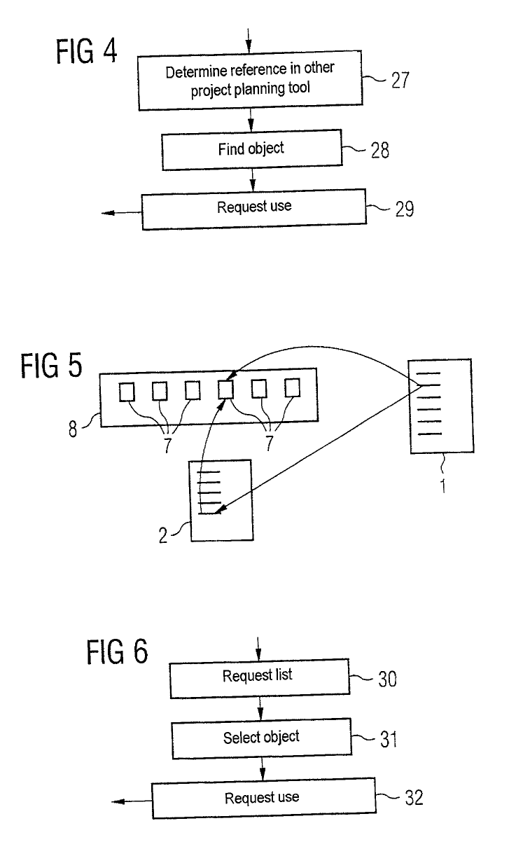

In accordance with FIGS. 4 and 5, it is possible for the purpose of requesting a use of an already existing global object 7 firstly to start from one of the project planning tools 1 to 3, for example the project planning tool 2, and select in a step 27 an already existing reference in one of the other project planning tools 1 to 3, for example the project planning tool 1. The assigned global object 7 is then determined in a step 28. Finally, in a step 29 the respective project planning tool 1 to 3, here the project planning tool 2, requests the use of this global object 7, and the reference thereto is generated.

A large part of this method remains hidden to the user. However, the user merely selects the mapping of the object (for example using a mouse control) and shifts it into the other project planning tool. This mode of procedure is generally known as drag and drop.

Alternatively, it is possible in accordance with FIG. 6 that the respective project planning tool 1 to 3 firstly requests in a step 30 of the management program 9 a list of the global objects 7 that are included in the data structure 8. In a step 31, one object is selected from the set of these global objects 7, and a use is requested in a step 32 of the management program 9. The method in accordance with FIG. 6 therefore constitutes a type of browsing through the list of the global objects 7.

The internal use of the global and local objects 7 by the project planning tools 1 to 3 is not discussed within the scope of the present invention. The point is that the use as such does not influence the global objects 7. Only modifications and deletions of global objects 7 are critical.

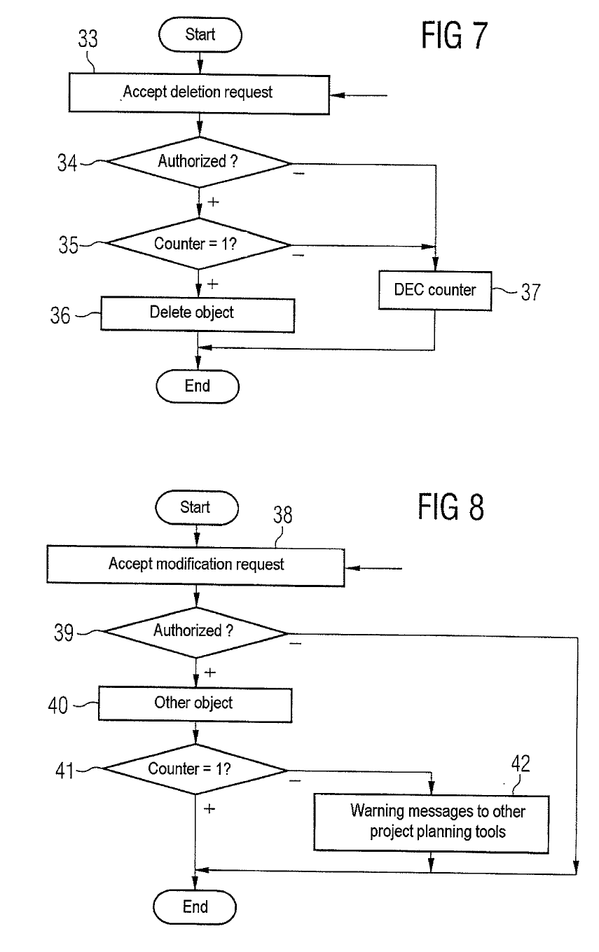

In order to ensure that in the event of deletion of uses by one of the project planning tools 1 to 3 the partial plans of the other project planning tools 1 to 3 remain as per design, in accordance with FIG. 7 the management program 9 is sent a deletion request which it accepts in a step 33. The management program 9 then checks in a step 34 whether the respective project planning tool 1 to 3 is in fact authorized for deletion. If yes, the management program 9 checks whether the counter 14 has the value 1 in a step 35.

If the counter has the value 1, the relevant global object 7 is deleted in a step 36. The point is that this global object 7 is then further used only by the project planning tool 1 to 3 which has now accepted the deletion request. On the other hand, the global object 7 is retained. Only the counter 14 is decremented in a step 37.

In a similar way, in accordance with FIG. 8 the management program 9 is also sent modification requests that it accepts in a step 38. In this case, the management program 9 checks in a step 39 whether the respective project planning tool 1 to 3 is authorized for modification. If yes, the modification is carried out in a step 40.

The value of the counter 14 is then again determined in a step 41. If this value is greater than 1, the management program 9 generates in a step 42 modification messages for the other project planning tools 1 to 3 which use this global object 7. These can then, in particular, accept the modification, or else generate a new global object 7.

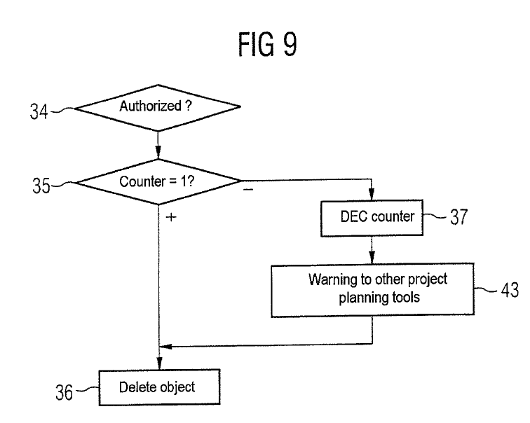

As an alternative to the suppression of the deletion of a global object 7 in the case when it is still being used by at least another one of the project planning tools 1 to 3, it is also possible in accordance with FIG. 9 to carry out the deletion of the global object 7 without fail in step 36. In this case, however, a branch should be made in step 35 to a step 43 in which the management program 9 generates a warning message for the other project planning tools 1 to 3. The point is that the other project planning tools 1 to 3 are then referred at least to the deletion, and so an appropriate correction of the project planning can be undertaken there.

Thus, as is to be seen from the above explanations, the global objects 7 can be generated, deleted and modified by the management program 9 as a function of the use by the project planning tools 1 to 3. In the event in this case of a modification of a global object 7 by use of one of the project planning tools 1 to 3 the management program 9 generates modification messages for the other project planning tools 1 to 3 using this global object 7. The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An object processing system including a data structure and a management program for the data structure, the data structure including global objects, comprising:
project planning tools for preparing partial plans of a technical installation, in accordance with tool-specific design criteria, wherein the data structure is accessible from the project planning tools only via the management program; and
the management program for at least one of generating, deleting, and modifying at least one of the global objects as a function of use by one of the project planning tools, wherein upon modification of a global object by one of the project planning tools, the management program generates at least one modification message for at least one of the other project planning tools using the global object.

2. The object processing system as claimed in claim 1, wherein the project planning tools internally generate a reference to the global object for each use of a global object via the respective project planning tool.

3. The object processing system as claimed in claim 2, wherein a use of a global object in one of the project planning tools is prescribed by selecting an existing reference in another one of the project planning tools, determining the assigned global object and internally generating a reference to the global object in the one project planning tool.

4. The object processing system as claimed in claim 1, wherein a use of a global object in one of the project planning tools is prescribed by selection from a list of the global objects.

5. The object processing system as claimed in claim 1, wherein preparation of an object via one of the project planning tools that is intended to be capable of use by at least one further project planning tool is interpreted by the management program as a request for generating a corresponding global object and for one project planning tool to use the global object.

6. The object processing system as claimed in claim 1, wherein the management program runs a reference counter for each global object, wherein the reference counter is set to a value one upon first-time use of the assigned global object, wherein the value of the reference counter is incremented with each use of the global object in another of the project planning tools, and wherein the value of the reference counter is decremented with each termination of the use of the global object in one of the project planning tools.

7. The object processing system as claimed in claim 6, wherein a deletion of the global object is undertaken only when the reference counter is already assigned the value one and the last use of the global object in one of the project planning tools is deleted.

8. The object processing system as claimed in claim 6, wherein a deletion of the global object is also undertaken when the reference counter is assigned a value differing from one, and wherein the management program generates a warning message on the basis of the deletion.

9. The object processing system as claimed in claim 1, wherein, upon generation of a global object via a requesting project planning tool, access authorizations for the other project planning tools are prescribed.

10. The object processing system as claimed in claim 1, wherein predefined object types are used for the generation of global objects.

11. The object processing system as claimed in claim 1, wherein the global objects are defined in a markup language.

12. The object processing system as claimed in claim 1, wherein the object model is a unit separated from the project planning tools.

13. The object processing system as claimed in claim 1, wherein the object model is integrated in one of the project planning tools.

14. The object processing system as claimed in claim 1, wherein the project planning tools are project planning tools for project planning a low-voltage power distribution system.

15. The object processing system as claimed in claim 1, wherein the project planning tools include at least two of the following project planning tools:
a project planning tool for preparing a circuit diagram,
a project planning tool for preparing a cable list,
a project planning tool for preparing a net list,
a project planning tool for preparing a parts list,
a project planning tool for preparing a terminal diagram,
a project planning tool for preparing an element specification,
a project planning tool for preparing a communication plan,
a project planning tool for at least one of testing and dimensioning a circuit diagram.

16. The object processing system as claimed in claim 2, wherein a use of a global object in one of the project planning tools is prescribed by selection from a list of the global objects.

17. The object processing system as claimed in claim 3, wherein a use of a global object in one of the project planning tools is prescribed by selection from a list of the global objects.

18. The object processing system as claimed in claim 2, wherein preparation of an object via one of the project planning tools that is intended to be capable of use by at least one further project planning tool is interpreted by the management program as a request for generating a corresponding global object and for one project planning tool to use the global object.

19. The object processing system as claimed in claim 2, wherein the management program runs a reference counter for each global object, wherein the reference counter is set to a value one upon first-time use of the assigned global object, wherein the value of the reference counter is incremented with each use of the global object in another of the project planning tools, and wherein the value of the reference counter is decremented with each termination of the use of the global object in one of the project planning tools.

20. An object processing method for a system including a data structure and a management program for the data structure, the data structure including global objects, comprising:
preparing partial plans of a technical installation using project planning tools, in accordance with tool-specific design criteria, wherein the data structure is accessible from the project planning tools only via a management program;
using the management program for at least one of generating, deleting, and modifying at least one of the global objects as a function of use by one of the project planning tools; and
generating, upon modification of a global object by one of the project planning tools, through the management program, modification messages for at least one of the other project planning tools using the global object.

21. The method as claimed in claim 20, wherein the project planning tools internally generate a reference to the global object for each use of a global object via the respective project planning tool.
